(19) United States
(12) Patent Application Publication
(10) Pub. No.: US 2025/0026062 A1
(43) Pub. Date: Jan. 23, 2025

(54) COUPLING OF PRODUCTION MACHINE AND STRETCH BLOW MOLDING MACHINE VIA AIR TRANSPORT

(71) Applicant: Krones AG, Neutraubling (DE)

(72) Inventors: Dieter WUENSCHE, Straubing (DE); Florian GELTINGER, Donaustauf (DE)

(21) Appl. No.: 18/773,227

(22) Filed: Jul. 15, 2024

(30) Foreign Application Priority Data
Jul. 19, 2023 (DE) 102023119038.5

(51) Int. Cl. B29C 49/42; B29C 49/06; B29K 67/00; B29L 31/00

(52) U.S. Cl. CPC B29C 49/42065; B29C 49/06; B29C 49/42073; B29K 2067/003; B29L 2031/712

(57) ABSTRACT

The disclosure relates to a container treatment plant for producing containers, comprising: a production machine, e.g., an injection-molding machine for producing preforms, at least one unit for producing containers from the preforms, at least one distribution apparatus for orderly distribution of the preforms produced by the production machine, at least one air conveyor for the orderly feeding of the preforms produced by the production machine to the at least one unit for producing containers from the preforms, wherein the distribution apparatus is configured to receive a plurality of the preforms, produced by the production machine, in an orderly manner in the form of a two-dimensional matrix arrangement and to transfer them in an orderly manner to the air conveyor.

### CROSS REFERENCE TO RELATED APPLICATION

The present application claims priority to German Patent Application No. 10 2023 119 038.5 filed on Jul. 19, 2023. The entire contents of the above-listed application are hereby incorporated by reference for all purposes.

### TECHNICAL FIELD

The disclosure relates to means for transferring preforms produced by injection-molding processes or by other processes to subsequent processes of a container treatment plant, in particular a plant in the food and beverage industry, with which the preforms are formed into containers—for example, by stretch blow molding.

### BACKGROUND

With known production processes for containers, in particular plastic containers, by stretch blow molding from preforms, the production of the preforms and the production of containers from the preforms are separated in terms of location and time.

### SUMMARY

In this way, for example, the preforms are produced at one location, stored as bulk material, and at a later point in time transported to a container production plant at another location, where they are sorted and separated again and fed to a stretch blow molding machine.

These well-known production processes are logistically very complex, expensive, and susceptible to failure.

Handling and storing preforms as bulk goods also often leads to damage to the preforms and to germ contamination. Complex sorting devices are also required to sort the preform bulk material before the preforms can be fed to a stretch blow molding machine in an orderly manner.

### Problem

It is thus an object of the disclosure to improve means for transferring preforms produced by injection-molding processes or by other processes to subsequent processes of a plant in the food and beverage industry, with which the preforms are formed into containers—for example, by stretch blow molding.

In particular, it is an object of the disclosure to improve the production efficiency, cost effectiveness, environmental compatibility, energy efficiency, quality, hygiene, sterility, and susceptibility to failure of known techniques and methods for transferring preforms produced by injection-molding processes or by other processes to subsequent processes of container production from said preforms.

### Solution

According to the disclosure, this is achieved by the subject matter described herein.

Advantageous embodiments and developments are the subject matter of the dependent claims.

In this way, the disclosure provides in particular a plant or a container treatment plant for producing containers, which can comprise the following components:
A production machine, e.g., an injection-molding machine, for producing preforms.
   At least one unit for producing containers from the preforms produced in the production machine.
   At least one distribution apparatus configured for the orderly distribution of the preforms produced by the production machine—for example, an injection-molding machine.
   At least one air conveyor configured for the orderly feeding of the preforms produced by the production machine, e.g., an injection-molding machine, to the at least one unit for producing containers from the preforms.

Said distribution apparatus can be configured to receive a plurality of the preforms, produced by the production machine, e.g., an injection-molding machine, in an orderly manner in the form of a two-dimensional matrix arrangement, and to be able to transfer them to the air conveyor in an orderly manner.

The production machine for the preforms can be designed as an injection-molding machine.

However, it is also conceivable that other types of production machines could be used for the preforms. In particular, production machines for preforms that can produce preforms using compression-molding methods or injection compression-molding methods are conceivable.

The containers and preforms described herein can in particular be understood to mean containers and preforms that consist of material comprising plastic materials, e.g., polyethylene terephthalate (PET), or that consist of plastic materials—for example, polyethylene terephthalate (PET).

The orderly distribution of preforms can be understood in particular to mean a distribution of preforms in which the preforms can be handled and/or transported in the form of a two-dimensional matrix and/or in the form of a one-dimensional matrix—for example, in a row or a line or a track or in a strand or in a track.

The orderly reception of preforms in the distribution apparatus can be understood in particular to mean a reception of the preforms in a two-dimensional matrix arrangement.

The orderly supply of the preforms produced by the production machine, e.g., an injection-molding machine, by means of the air conveyor to the at least one unit for producing containers from the preforms can be understood in particular to mean a feed or transport or handling of the preforms, in which preforms can be handled and/or transported in the form of a one-dimensional matrix—for example, in a row or a line or a column or a track or in a strand or in a track.

In particular, the air conveyor can be configured to transport the preforms, taken from the distribution apparatus, in an orderly manner in a row to the at least one unit for producing containers from the preforms. The air conveyor can be designed as a shaft or channel, for example, and can be operated by means of compressed air.

Orderly feeding or supplying can also be understood to mean that the preforms can be fed at a predeterminable pitch or at a predeterminable spacing of adjacent preforms to the unit for producing containers from the preforms.

An orderly transfer of the preforms from the distribution apparatus to the air conveyor can be understood to mean that the preforms can be transferred to the air conveyor in the form of a one-dimensional matrix—for example, in a row or a line or a column or a track or in a strand or in a track.

For example, the distribution apparatus can be configured to be able to selectively transfer preforms from individual rows or individual columns from the two-dimensional matrix arrangement of received preforms to the air conveyor.

Thus, the preforms in the container treatment plant can assume a well-defined, traceable, and reproducible position within the container treatment plant at any time and at any location in the container treatment plant.

Thus, the container treatment plant described herein operates entirely without any sorting device for preforms.

This would not be possible when handling preforms as bulk material.

In the container treatment plant described herein, it is therefore possible that the preforms do not have to be treated as bulk material at any time.

Such a container treatment plant for producing containers offers numerous advantages over known plants.

In particular, by directly linking or interlinking the production process for the preforms and the production of containers from the preforms at the same location, it is possible, for example, to significantly reduce or completely eliminate transport and storage costs for the preforms, since the preforms no longer have to be transported over long distances from a plant for producing the preforms to the container production plant.

As a result, the logistics of container production can be significantly simplified and reduced.

Undesirable damage to the preforms, which can occur, e.g., during storage or transport of the preforms as bulk material, can also be almost completely avoided.

The orderly reception of the preforms in the distribution apparatus, followed by the orderly transfer of the preforms from the distribution apparatus to the air conveyor and the subsequent orderly feeding of the preforms by means of the air conveyor to the/a downstream unit for producing containers from the preforms means that the use of complex and failure-susceptible sorting devices for the preforms can be dispensed with.

In addition, the orderly handling of the preforms enables better tracking, i.e., improved track & trace of the preforms through the plant, which facilitates quality monitoring of the plant or the container production.

The time between the production of the preform and the production of the container from the preform can be significantly reduced compared to known container production methods.

Possible undesirable changes in the properties of the preform, e.g., with regard to its material properties and/or with regard to its dimensional stability, which could result from long storage times or long transport times of the preform and which could have a detrimental effect on the stretch blow molding process, can also be reduced or avoided.

This can have a positive effect on the quality of the containers produced.

The risk of germ contamination of the preforms can also be avoided or reduced by the shortened production process between the production of the preform and the production of the container from the preform, and by avoiding transport or storage of the preforms as bulk material.

In this way, for example, the sterility of the preforms provided by the production process, e.g., an injection-molding production process, can be better utilized, since, for example, the preforms heated by the production process, e.g., an injection-molding production process, and sterilized by the production heat can be further processed immediately, i.e., without delays.

Thus, higher sterility rates and improved hygiene of the containers produced can be achieved.

Therefore, the container treatment plant described herein is suitable for the aseptic production and filling of containers made from the preforms.

In particular, for example, the air conveyor can be designed as an aseptic air conveyor, wherein the air conveyor can be operated with sterile air, for example.

This also contributes to increased sterility and improved hygiene of the containers produced.

The distribution apparatus can be designed to be displaceable transversely to the transport direction of the air conveyor.

In this way, among other things, greater flexibility in the transfer of preforms from the distribution apparatus to the air conveyor can be achieved.

It is conceivable, for example, that the distribution apparatus can move to different transfer positions in a targeted manner to the air conveyor or to a plurality of different air conveyors.

Alternatively, and furthermore, it is conceivable that the distribution apparatus can thus transfer or discharge in a targeted manner individual columns of the rows of the two-dimensional matrix arrangement, in which the preforms can be located in the distribution apparatus, to the air conveyor.

The distribution apparatus can have receptacles or holders for the preforms to be received.

The holders or receptacles can be designed to be movable and controllable and can, for example, be moved controllably between a holding position, in which the preforms are received and held in the distribution apparatus, and a release position, in which the preforms are no longer held by the receptacles or holders of the distribution apparatus.

This can facilitate an orderly transfer of the preforms received by the distribution apparatus to the air conveyor.

In all other respects, the control of the movement of the holders or receptacles of the distribution apparatus can be controlled by a control unit of the container treatment plant.

The distribution apparatus can have a plurality of movable support rails, and said holders or receptacles for the preforms to be received by the distribution apparatus can be formed by the support rails.

Said support rails can be designed such that the preforms with their support rings hanging in the support rails, in particular hanging vertically and in the direction of gravity, can be received in the distribution apparatus in the holding position.

Said support rails can also be designed such that they can be moved from the holding position to the release position, wherein the preforms are no longer held by the support rails in the release position and can be transferred to the air conveyor.

This can be made possible by a release mechanism that can move the support rails accordingly—for example, folding them away or pulling them apart or moving them apart.

This can facilitate an orderly transfer of the preforms received by the distribution apparatus to the air conveyor.

Pairs of support rails can be arranged in parallel and spaced apart from one another.

In said holding position, the preforms received by the distribution apparatus can in each case be held by opposite support rails of a pair of support rails.

Said pairs of support rails can be configured or arranged such that they can define a row or column of the two-dimensional matrix arrangement in which preforms can be received in the distribution apparatus.

In order to be able to reach a release position, for example, the pairs of support rails can then be spread apart, moved apart, or folded away in order to transfer the preforms to the air conveyor row-by-row or column-by-column.

Said support rails can be moved along guide bars, for example, or moved by means of articulated elements.

This can also facilitate an orderly and flexible transfer of the preforms received by the distribution apparatus to the air conveyor.

Said exemplary support rails can each be formed from individual modules, wherein the modules are able to be lined up in a row.

Alternatively, a plurality of support rails can be formed from one unit.

This exemplary modular design enables the easy adaptation of the application options, dimensioning, and capacity of the distribution apparatus to different production requirements or production changes, such as, for example, adaptation to different production rates or different container types or different preform types.

Alternatively, the distribution apparatus can be designed as follows.

The distribution apparatus can have at least one track for transporting the received preforms and at least one outlet leading to the air conveyor.

A portion of the at least one track can define at least one row of the two-dimensional matrix arrangement, in which the preforms can be received in the distribution apparatus.

The distribution apparatus can be configured to transport the received preforms along the at least one track to the at least one outlet of the distribution apparatus, in order to be able to transfer the received preforms to the air conveyor.

Thus, the air conveyor can be coupled directly to an outlet of the distribution apparatus.

The distribution apparatus in this design can have a plurality of support rails, which can define the at least one track, and wherein the support rails can be designed such that the preforms can be transported with their support rings suspended in the support rails, in particular suspended vertically and in the direction of gravity.

The at least one track can also be understood as a channel or shaft in which the preforms can move or in which the preforms can be transported.

The support rails can define the edges or the boundary of at least one track. The preforms can then be transported within the track—for example, with their support rings suspended between adjacent support rails.

The support rails can also be understood as guide rails, which can guide the preforms through the distribution apparatus and wherein the preforms can slide along the support rails via their support rings.

The distribution apparatus can also be configured to transport the preforms along the at least one track by applying compressed air.

Thus, the distribution apparatus itself can also be designed as an air conveyor.

For example, the distribution apparatus can have air shafts with louvers along the at least one track, via which the compressed air can be supplied for moving or conveying the preforms along the at least one track.

Alternatively or additionally, the distribution apparatus can be configured to mechanically transport the preforms along the at least one track.

For example, the distribution apparatus can have a large number of mechanically drivable carriers, e.g., carrier cams, which can be configured to transport the received preforms along the at least one track defined by the support rails to the at least one outlet of the distribution apparatus, for transfer to the air transport, which can then further transport the preforms in an orderly manner to the at least one unit for producing containers from the preforms.

The exemplary drivable carriers can be configured such that they can come into contact with the preforms—for example, into contact with the support rings of the preforms and/or into contact with a surface of the preform below and/or above the support ring.

The exemplary drivable carriers can project into at least one track. For example, the drivable carriers can project into the track up to the center line of at least one track, or even further.

The distribution apparatus can also comprise circulating transport means, e.g., transport conveyors or transport chains or transport belts, which can be assigned to the support rails, and wherein the carriers for transporting the preforms can be attached to the circulating transport means.

The circulating transport means can be driven by controllable drive rollers, for example.

The exemplary circulating transport means can be connected to the support rails or can be spaced apart from them, i.e., not be in contact with the support rails.

The distribution apparatus can be configured such that the preforms can move along at least one well-defined movement direction or along at least one well-defined transport movement direction along the at least one track.

The movement direction of the preforms can, for example, correspond to or be parallel to the movement direction of the carriers of the circulating transport means.

Alternatively, however, it is possible that the movement direction of the carriers of the circulating transport means can enclose an angle, e.g., an angle of 1° or greater, with a transport movement direction of a preform along at least a part, in particular along a rectilinear part or segment, of the track.

This, among other things, prevents, for example, carriers from different circulating transport means, which are assigned to adjacent and opposite support rails, from colliding with one another. Damage to the distribution apparatus can thus be avoided.

Alternatively or additionally, carriers of different circulating transport means, which are assigned to adjacent and opposite support rails, can be arranged offset to one another.

The distribution apparatus can also be configured to optionally transport the preforms along different, in particular opposite, directions of movement or opposite transport movement directions.

Alternatively or additionally, the distribution apparatus can have a plurality of outlets for the preforms, wherein the distribution apparatus can be configured to transport the preforms selectively to one outlet or to a plurality of outlets.

While, for example, one outlet of the distribution apparatus can lead to the air conveyor, which can then further transport the preforms in an orderly manner on to the at least one unit for producing containers from the preforms, another outlet of the distribution apparatus can lead to another unit of the container treatment plant—for example, to an inspection unit or to a scrap collecting unit.

As already described, the distribution apparatus can be configured to selectively transport the preforms along different, in particular opposite, directions of movement or opposite transport movement directions.

For example, the distribution apparatus can comprise circulating transport means whose transport circulation direction is controllable and can be reversed.

In all other respects, the control of the movement of the circulating transport means of the distribution apparatus can be controlled by a/the control unit of the container treatment plant.

In this way, the preforms can be transported in an orderly, e.g., single-lane or single-line, and controlled manner to the various possible outlets.

This increases the flexibility of the distribution apparatus and thus the efficiency and flexibility of the plant.

By lining up the preforms in a track and separating them, e.g., by the carriers of the circulating transport means, it is also possible to position individual preforms above an ejection point and discharge them in a targeted manner.

The possible orderly, single-line or single-lane, output of preforms in a row, spaced apart from one another by the carriers of the circulating transport means via the outlet or outlets of the distribution apparatus, enables a more precise control and regulation of the flow of preforms through the container treatment plant.

Said exemplary support rails can each be formed from individual modules, wherein the modules are able to be lined up in a row.

Alternatively, a plurality of support rails can be formed from one unit.

This exemplary modular design enables the easy adaptation of the application options, dimensioning, and capacity of the distribution apparatus to different production requirements or production changes, such as, for example, adaptation to different production rates or different container types or different preform types.

In all the design options described above, or in all the embodiments described above, the distribution apparatus can be configured to receive, at the same time in an orderly manner, a multiple of the number of preforms that can be produced per cycle of the injection-molding machine.

For example, the distribution apparatus can be configured to hold 50 to 300 preforms at the same time in an orderly manner.

The matrix arrangement form of the distribution apparatus in all described design options or in all embodiments described above can, for example, be dimensioned such that a matrix arrangement form of the shaping tool of the production machine, e.g., an injection-molding machine, can be a partial matrix of the matrix arrangement form of the distribution apparatus.

If, for example, 100 preforms of the shaping tool of the production machine, e.g., an injection-molding machine, are arranged in a 10×10 matrix, the matrix arrangement form of the distribution apparatus can, for example, be designed as a 20×10 matrix, so that the distribution apparatus can receive two cycles of preforms produced by the production machine—for example, an injection-molding machine.

Alternatively, the matrix arrangement form of the distribution apparatus can, for example, be dimensioned such that it can correspond exactly to the dimensioning of the matrix arrangement form of the shaping tool of the production machine, e.g., an injection-molding machine, so that the distribution apparatus can receive exactly the number of preforms that can be produced in one cycle of the production machine—for example, an injection-molding machine.

The specified exemplary coordination of the dimensioning of the matrix arrangement form of the distribution apparatus and the matrix arrangement form of the shaping tool of the production machine, e.g., an injection-molding machine, can improve the efficiency of the container treatment plant for producing containers.

The container treatment plant described above and herein can further comprise at least one automatic handling unit, e.g., a robot, wherein the automatic handling unit, e.g., the robot, can have at least one gripper, and the at least one gripper can be configured to remove preforms from the shaping tool of the production machine, e.g., an injection-molding machine, and to transfer them to the distribution apparatus in an orderly manner in the form of the/a two-dimensional matrix arrangement.

The at least one gripper of the automatic handling unit, e.g., of the robot, can also have a plurality of gripping elements, wherein the gripping elements in each case can be clearly assignable or assigned to a preform of the shaping tool of the production machine—for example, an injection-molding machine.

This can facilitate a well-defined and orderly transfer of the preforms to the unit for producing containers from the preforms.

The exemplary gripping elements of the at least one gripper of the automatic handling unit, e.g., of the robot, can be arranged in a grid or in a matrix, which can correspond to the grid or which can correspond to the two-dimensional matrix arrangement, in which the preforms can be arranged in the shaping tool of the production machine, e.g., injection-molding machine, and in which the preforms can be received by the distribution apparatus.

The exemplary gripping elements of the at least one gripper of the automatic handling unit, e.g., of the robot, can also be designed to be individually controllable.

This can improve the flexibility and precision of handling and transferring the preforms to the distribution apparatus.

The at least one gripper of the automatic handling unit, e.g., of the robot, or at least one gripping element of the gripper of the automatic handling unit, e.g., of the robot, can be configured or designed such that the force for gripping and/or for holding the preforms can be transferred by force fit and/or frictional fit and/or form fit and/or in combination with the use of a fluid flow—for example, by means of the application of a vacuum.

The said at least one unit for producing containers from the preforms, to which the preforms can be transported by the air conveyor coupled to the distribution apparatus, can, for example, be a unit of the following type: infeed unit of a stretch blow molding machine, infeed unit of a heating section, conveyor unit, transport unit, transport diverting unit for further dividing and/or further diverting the preform flow through the plant, infeed of a preform cleaning unit, inspection unit, scrap collecting unit.

Thus, the combination of distribution apparatus and air conveyor described above and herein can be used flexibly and can feed preforms to the various units of the container treatment plant.

The disclosure also provides not only a container treatment plant for producing containers, as described above, but also a distribution apparatus for preforms for use in a container treatment plant for producing containers, as described above, and wherein the distribution apparatus can be configured to receive a plurality of the preforms, produced by the production machine, e.g., an injection-molding machine, in an orderly manner in the form of a two-dimensional matrix arrangement, and to transfer them in an orderly manner to an air conveyor.

The distribution apparatus can have some or all of the features described above.
The disclosure also provides a method for handling preforms in a container treatment plant for producing containers as described above, which can comprise some or all of the following steps:
An (orderly) removal of the preforms from a shaping tool of the injection-molding machine.
An orderly transfer of the removed preforms to a distribution apparatus, wherein the distribution apparatus is configured to receive a plurality of the preforms, produced by the production machine, e.g., an injection-molding machine, in an orderly manner in the form of a two-dimensional matrix arrangement.
An orderly transfer of the preforms from the distribution apparatus to an air conveyor.
An orderly transport of the preforms by means of the air conveyor to the at least one unit for producing containers from the preforms—for example, a stretch blow molding machine.

As mentioned above, the terms “orderly removal,” “orderly transfer,” and “orderly transport” of preforms can be understood in particular to mean a handling of preforms in which preforms can be arranged and moved in a well-defined manner in the form of a two-dimensional matrix arrangement and/or in the form of a one-dimensional matrix arrangement or in the form of a row or in the form of a column or in the form of a line or in the form of a strand or in the form of a track.

### BRIEF DESCRIPTION OF THE FIGURES

Further exemplary aspects of the disclosure or exemplary aspects of the claim features are illustrated by way of example by the following figures.

FIG. 1A: Exemplary distribution apparatus for preforms

FIG. 1B: Exemplary alternative distribution apparatus for preforms

FIG. 1C: Exemplary release mechanism

FIG. 2: Exemplary method

FIG. 3: Exemplary container treatment plant

### DETAILED DESCRIPTION

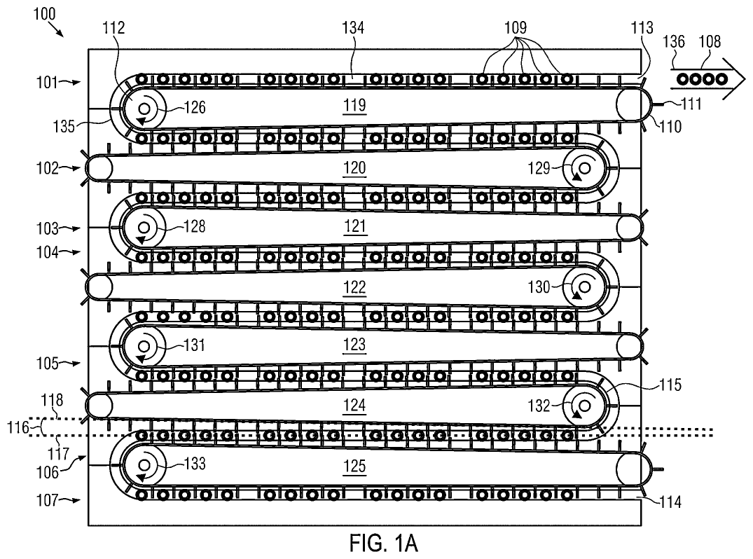

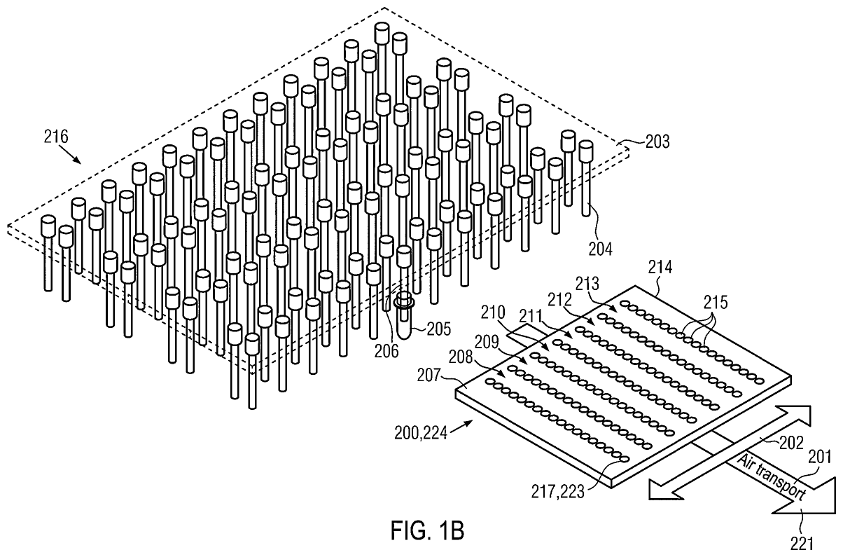

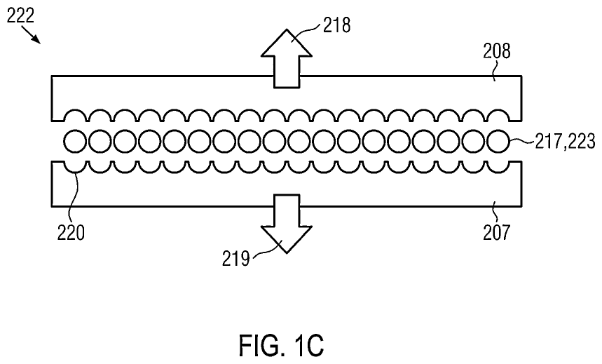

FIG. 1A shows an exemplary top view of an exemplary distribution apparatus 100, which has received a plurality of preforms 109 in an exemplary two-dimensional matrix arrangement.

These preforms 109 can, for example, originate directly from a shaping tool of a production machine (not shown), e.g., an injection-molding machine, or may have been transferred from the shaping tool of a production machine, e.g., an injection-molding machine, to the distribution apparatus 100 by an automatic handling unit—for example, a robot (not shown).

In the example shown, this is a matrix arrangement with eight rows and eighteen columns, i.e., an 8×18 matrix, in which 144 preforms are thus received and can be transported along the exemplary track 115 within the distribution apparatus 100.

The width of the track 115 can, for example, correspond to the average diameter of the preforms 109 and can be slightly smaller than the average diameter of the support rings of the preforms.

Other matrix arrangements or other fillings of the distribution apparatus 100 are also conceivable. In this way, not every space in the matrix has to be filled with preforms. In the example shown, not all matrix slots are actually occupied; instead, there are still free slots or gaps available in which further preforms could be received.

The filling of the distribution apparatus 100 can be flexibly adapted to the desired pitches or cycles for the orderly preform stream to be output.

In the example shown, the distribution apparatus 100 has two exemplary outlets 113, 114, and the exemplary track 114 extends between the two outlets 113, 114.

The exemplary track 115 is formed by the arrangement of the exemplary support rails or support rail modules 101, 102, 103, 104, 105, 106, 107, which can transport the preforms 109 with their support rings suspended in the support rails, wherein, for example, the support rings of the preforms can be supported and guided by opposite support rails.

In other words, the preforms 109 can be transported with their support rings suspended in the track channel 115, which can be formed by two opposite support rails.

The track 115 can have a plurality of rectilinear segments, which can be parallel to one another and can define the rows of the exemplary two-dimensional matrix arrangement.

Said rectilinear segments of the track 115 can be connected to one another via curved segments.

As an example, the uppermost rectilinear segment of the track 115 is provided with the reference sign 134 in the figure, which adjoins the curve segment 135.

The support rails or support rail modules 101, 102, 103, 104, 105, 106, 107 can in each case comprise circulating transport means 119, 120, 121, 122, 123, 124, 125, which can be designed, for example, as circulating transport belts with carriers.

The exemplary circulating transport means 119, 120, 121, 122, 123, 124, 125 or the circulating transport belts can in each case be driven by drive rollers.

The exemplary circulating transport means 119, 120, 121, 122, 123, 124, 125 can also have deflection rollers (not shown), which can lie opposite the respective drive rollers.

For reasons of clarity, only the conveyor belt 110 with carriers 111 and drive roller 112 have been provided with reference signs.

The drive rollers and their directions of rotation can be controlled such that, for example, the directions of rotation of the drive rollers can be reversed.

Exemplary directions of rotation of the drive rollers are provided with the reference signs 126, 127, 128, 129, 130, 131, 132, 133.

In the illustrated exemplary configuration of the drive rollers, the preforms 109 received by the distribution apparatus are guided, for example, to the outlet 113, where they are output, for example, and transferred there, for example, to an air conveyor 136, which can then transport the preforms further to a unit (not shown) for producing containers from the preforms.

The reference sign 108 indicates, for example, preforms output at the outlet 113, which can then be transported further via the air conveyor 136 to a unit (not shown) for producing containers from the preforms.

With an exemplary reversal of the directions of rotation 126, 127, 128, 129, 130, 131, 132, 133 of the drive rollers, the preforms 109 received by the apparatus 100 would, for example, be guided to the outlet 114 and could be output there, for example, to another unit (not shown) of the container treatment plant—for example, an inspection unit.

In order to mitigate the susceptibility of the distribution apparatus 100 to failure and to ensure trouble-free transport of the preforms 109 within the distribution apparatus 100, the circulating transport means can be configured such that the movement direction of the carriers of the circulating transport means can enclose an angle, e.g., an angle of 1° or greater, with a transport movement direction of a preform along a rectilinear segment of the track.

Thus, the contour of the circulating transport means 119, 120, 121, 122, 123, 124, 125 can be conical.

In the example shown, for example, the movement direction 118 of the carriers of the circulating transport means 124 and the transport movement direction 107 of the preforms along the rectilinear track segment between the transport means 124 and the transport means 125 have been marked, and the exemplary angle 116 between the two directions has been drawn in.

This exemplary design of the geometry of rectilinear track segments and the circulating transport means surrounding the rectilinear track segments can be realized (as shown) for each rectilinear track segment of the distribution apparatus 100.

Thus, opposite carriers of opposite transport means can move parallel to one another along the rectilinear track segments and project into the track up to the center line of the rectilinear track segments, in order to be able to make optimum contact with the preforms to be transported.

A collision of opposite carriers during operation of the distribution apparatus 100 can thus be avoided.

Alternatively, however, it is conceivable that the distribution apparatus can be designed such that the movement direction of the preforms corresponds to the movement direction of the carriers of the circulating transport means or can be parallel to it.

In this case, for example, carriers from different circulating transport means, which are assigned to adjacent and opposite support rails, could be arranged offset to one another.

FIG. 1B shows, in a partially schematically simplified form, an alternative distribution apparatus 200 that has received a plurality of preforms 215 in an exemplary two-dimensional matrix arrangement.

The preforms can, for example, be removed by an automatic handling unit 216, e.g., a robot, from a shaping tool of a production machine (not shown), e.g., an injection-molding machine, and transferred to the distribution apparatus 200.

The (movable) automatic handling unit 216, e.g., a/the (movable) robot, can for example have a (movable) gripper 203, which can have a large number of (individually controllable) gripping elements 204, wherein the gripping elements 204 can receive, handle, transport, and transfer preforms 205.

For reasons of clarity, only one exemplary preform 205 has been drawn in the figure, which is held by a gripping element 206 of the automatic handling unit 216—for example, a robot.

The gripping elements 204 can, for example, be arranged in the form of a matrix, which can correspond to the matrix arrangement of the preforms in the shaping tool of the/a production machine (not shown), e.g., an injection-molding machine, and/or which can correspond to the two-dimensional matrix arrangement of the preforms in the distribution apparatus 200.

The distribution apparatus 200 can have a large number of movable support rails or movable support rail modules 207, 208, 209, 210, 211, 212, 213, 214, which can receive the preforms with their support rings suspended in the support rails in the distribution apparatus in a/the holding position.

For example, the preforms 223 can be received in the row or column 217 of the two-dimensional matrix arrangement of the distribution apparatus 200 and held in a holding position by the/one pair of support rails formed by the support rails 207, 208.

In the example shown, all support rails 207, 208, 209, 210, 211, 212, 213, 214 of the distribution apparatus 200 are shown in a/the holding position 224.

The movable support rails or the movable support rail modules 207, 208, 209, 210, 211, 212, 213, 214 can be moved from a/the holding position shown to a release position. For example, the movable support rails can be moved apart, e.g., along guide bars not shown, in order to reach said release position in which the preforms are no longer held by the support rails, in order to then be able to be transferred to the air conveyor.

In the release position, for example, the preforms can fall or slide down by simple gravity onto a shaft-like or channel-like air conveyor 201 arranged below the distribution apparatus, in order to then be able to be transported further by the air conveyor in the direction 221 to the at least one unit for producing containers from the preforms.

Such an exemplary movement or an exemplary release position is shown in FIG. 1C.

The entire distribution apparatus 200 can be displaceable or movable transversely or orthogonally to the transport direction 221 of the air conveyor 201. The exemplary directions of movement of the entire distribution apparatus 200 are marked with the reference sign 202.

In this way, individual rows or columns of preforms can be transferred from the distribution apparatus 200 to the air conveyor 201 in a targeted and orderly manner.

FIG. 1C shows by way of example a possible movement of support rails of a distribution apparatus to reach a release position, in which preforms can be transferred from the distribution apparatus to an air conveyor.

In particular, FIG. 1C shows by way of example the movement 218, 219 of the support rails 207 and 208 of the distribution apparatus 200 of FIG. 1B into an exemplary release position 222, in which the preforms 223 are no longer held by the support rails 207, 208, in order to then be able to be transferred to the air conveyor 221 (see FIG. 1B).

In this way, for example, the preforms 223 of the row or column 217 can then be transferred to the air conveyor 221 (see FIG. 1B) in an orderly and targeted manner at the same time, wherein the air conveyor 221 (see FIG. 1B) can be located below the distribution apparatus 200, i.e., below the support rails 207 and 208.

In addition, FIG. 1C shows by way of example that the support rails can have exemplary, optional bulges, which can make it easier to receive and hold the preforms.

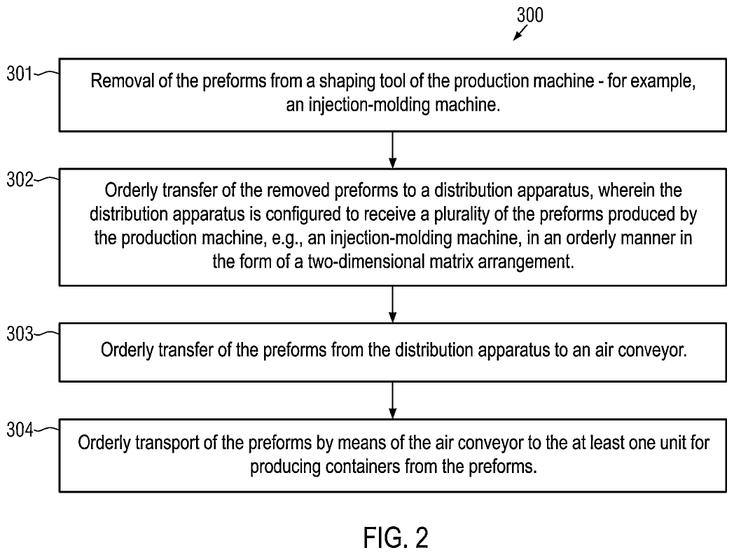

FIG. 2 shows an exemplary flow diagram for an exemplary method 300 for handling preforms in a container treatment plant for producing containers, wherein the container treatment plant can have some or all of the features described above.

The exemplary method 300 can comprise, but is not limited to, the following steps:
An (orderly) removal of the preforms from a shaping tool of the production machine—for example, an injection-molding machine.
An orderly transfer of the removed preforms to a distribution apparatus, wherein the distribution apparatus is configured to receive a plurality of the preforms, produced by the production machine, e.g., an injection-molding machine, in an orderly manner in the form of a two-dimensional matrix arrangement.
An orderly transfer of the preforms from the distribution apparatus to an air conveyor.
An orderly transport of the preforms by means of the air conveyor to the at least one unit for producing containers from the preforms—for example, a stretch blow molding machine.

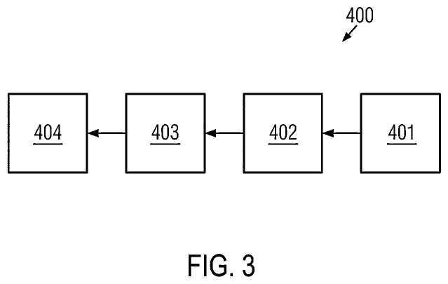

FIG. 3 schematically shows by way of example a container treatment plant 400 for producing containers, comprising: a production machine 401, e.g., an injection-molding machine, for producing preforms, at least one unit 404 for producing containers from the preforms, at least one distribution apparatus 402 for orderly distribution of the preforms produced by the production machine 401, e.g., an injection-molding machine, and at least one air conveyor 403 for orderly feeding of the preforms produced by the production machine 401, e.g., an injection-molding machine, to the at least one unit 404 for producing containers from the preforms, and wherein the distribution apparatus 402 is configured to receive a plurality of the preforms, produced by the production machine, such as an injection-molding machine, in an orderly manner in the form of a two-dimensional matrix arrangement and to transfer them to the air conveyor 403 in an orderly manner.

The exemplary unit 403 can be a stretch blow molding machine, for example.

FIGS. 1A, 1B, 2, and 3 follow.

The reference signs are assigned as follows.
100 Distribution apparatus
101, 102, 103, 104, 105, 106, 107 Module or support rail or support rail module
108 Preforms or output preforms
109 Preforms or received preforms
110 Belt or circulating belt
111 Carrier or carrier cam
112 Drive roller
113 Outlet
114 Outlet
115 Track or channel or track channel
116 Angle between the transport movement direction of the preforms and the movement direction of the carriers
117 Transport movement direction of the preforms
118 Movement direction of the carriers of the belt 110 of the transport means 119
119, 120, 121, 122, 123, 124, 125 Circulating transport means
126, 127, 128, 129, 130, 131, 132, 133 Movement direction(s) of the drive roller(s)
134 Rectilinear track segment
135 Curved segment of the track
136 Air conveyor
200 Distribution apparatus
201 Air conveyor
202 Movement direction(s) of the distribution apparatus
203 Gripper
204 Gripping element
205 Preform
206 Gripping element
207, 208, 209, 210, 211, 212, 213, 214 Support rail or support rail module
215 Preforms
216 Automatic handling unit—for example, robot
217 Row or column
218 Movement direction of the support rail
219 Movement direction of the support rail
220 Receptacle or holder, exemplary bulge
221 Transport direction of the air conveyor
222 Release position
223 Preforms
224 Holding position
300 Method
301, 302, 303, 304 Method steps
400 Container treatment plant
401 Production machine—for example, injection-molding machine
402 Distribution apparatus
403 Air conveyor
404 Unit for producing containers from the preforms—for example, stretch blow molding machine

1. Container treatment plant for producing containers, comprising:
a production machine for producing preforms,
at least one unit for producing containers from the preforms,
at least one distribution apparatus for the orderly distribution of the preforms produced by the production machine,
at least one air conveyor for the orderly feeding of the preforms produced by the production machine to the at least one unit for producing containers from the preforms,
wherein the distribution apparatus is configured to receive a plurality of the preforms, produced by the production machine, in an orderly manner in the form of a two-dimensional matrix arrangement and to transfer them to the air conveyor in an orderly manner.

2. Container treatment plant according to claim 1, wherein the distribution apparatus is configured to transfer a portion of the received preforms to the air conveyor in an orderly manner in a row, and wherein the air conveyor is configured to transport the preforms, received from the distribution apparatus, in an orderly manner in a row to the at least one unit for producing containers from the preforms.

3. Container treatment plant according to claim 1, wherein the distribution apparatus is displaceable transversely to the transport direction of the air conveyor and/or wherein the air conveyor is an aseptic air conveyor.

4. Container treatment plant according to claim 1, wherein the distribution apparatus has receptacles for the preforms to be received and wherein the receptacles are movable between a holding position in which the preforms are received and held in the distribution apparatus and a release position in which the preforms are no longer held by the receptacles of the distribution apparatus.

5. Container treatment plant according to claim 4, wherein the distribution apparatus has a plurality of movable support rails and wherein the receptacles for the preforms to be received are formed by the support rails, and the support rails are designed such that the preforms can be received with their support rings suspended in the support rails in the distribution apparatus in the holding position, and wherein the support rails are configured such that they can be moved from the holding position to the release position, wherein the preforms are no longer held by the support rails in the release position and can be transferred to the air conveyor.

6. Container treatment plant according to claim 5, wherein pairs of support rails are arranged parallel to one another at a distance, and preforms in the holding position can in each case be held by opposite support rails of a pair of support rails, and the pairs of support rails are configured to define a row or column of the two-dimensional matrix arrangement.

7. Container treatment plant according to claim 1, wherein the distribution apparatus has at least one track for transporting the received preforms and at least one outlet leading to the air conveyor, wherein a portion of the at least one track defines at least one row of the two-dimensional matrix arrangement, and wherein the distribution apparatus is configured to transport the received preforms along the at least one track to the at least one outlet of the distribution apparatus, in order to be able to transfer the received preforms to the air conveyor.

8. Container treatment plant according to claim 7, wherein the distribution apparatus has a plurality of support rails that define the at least one track, and wherein the support rails are designed such that the preforms can be transported with their support rings suspended in the support rails.

9. Container treatment plant according to claim 8, wherein the distribution apparatus has a number of mechanically drivable carriers, which are configured to transport the received preforms along the at least one track defined by the support rails to the at least one outlet of the distribution apparatus.

10. Container treatment plant according to claim 9, wherein the distribution apparatus further comprises circulating transport means, which are assigned to the carrying bars, and wherein the carriers for transporting the preforms are attached to the circulating transport means.

11. Container treatment plant according to claim 1, wherein the distribution apparatus is configured to receive, at the same time in an orderly manner, a multiple of the number of preforms that can be produced per cycle of the production machine, and/or wherein the distribution apparatus is configured to receive 50 to 300 preforms at the same time in an orderly manner.

12. Container treatment plant according to claim 1, further comprising at least one automatic handling unit, wherein the automatic handling unit, has at least one gripper, and the at least one gripper is configured to remove preforms from the shaping tool of the production machine and to transfer them to the distribution apparatus in an orderly manner in the form of the/a two-dimensional matrix arrangement.

13. Container treatment plant according to claim 1, wherein the at least one unit for producing containers from the preforms is a unit of the following type: infeed unit of a stretch blow molding machine, infeed unit of a heating section, conveyor unit, infeed of a preform cleaning unit, inspection unit, scrap collecting unit.

14. Distribution apparatus for preforms for use in a container treatment plant for producing containers according to claim 1, wherein the distribution apparatus is configured to receive a plurality of the preforms, produced by a/the production machine, in an orderly manner in the form of a two-dimensional matrix arrangement and to transfer them in an orderly manner to an/the air conveyor.

15. Method for handling preforms in a container treatment plant for producing containers according to claim 1, comprising:
a removal of the preforms from a shaping tool of the production machine;
an orderly transfer of the removed preforms to a distribution apparatus, wherein the distribution apparatus is configured to receive a plurality of the preforms, produced by the production machine, in an orderly manner in the form of a two-dimensional matrix arrangement;
an orderly transfer of the preforms from the distribution apparatus to an air conveyor; and an
orderly transport of the preforms by means of the air conveyor to the at least one unit for producing containers from the preforms.

16. Container treatment plant according to claim 1, wherein the production machine is an injection molding machine.
